(19) United States
(12) Patent Application Publication
(10) Pub. No.: US 2013/0265305 A1
(43) Pub. Date: Oct. 10, 2013

(54) Compressed Depth Cache

(71) Applicants: Jon N. Hasselgren, Bunkeflostrand, M (SE); Magnus Andersson, Helsingborg, M (SE); Jim K. Nilsson, Lund, M (SE); Tomas G. Akenine-Moller, Lund, M (SE)

(72) Inventors: Jon N. Hasselgren, Bunkeflostrand, M (SE); Magnus Andersson, Helsingborg, M (SE); Jim K. Nilsson, Lund, M (SE); Tomas G. Akenine-Moller, Lund, M (SE)

(21) Appl. No.: 13/627,093

(22) Filed: Sep. 26, 2012

Related U.S. Application Data
(60) Provisional application No. 61/620,045, filed on Apr. 4, 2012.

(51) Int. Cl. G06T 15/40

(52) U.S. Cl. 345/422

(57) ABSTRACT

A depth cache keeps the depth data in compressed format when possible. This involves a more flexible cache implementation, where a tile may occupy a variable amount of cache lines depending on whether it can be compressed or not. One advantage of some embodiments this depth cache is that the effective cache size increases proportionally to the compression ratio. The memory bandwidth can be reduced, compared to a system compressing the data after the cache in some embodiments. Alternatively, pre-cache compression may increase the effective cache size by a factor of two or more, compared to a post-cache compressor, at equal or higher performance.

### CROSS-REFERENCE TO RELATED APPLICATION

This application is a non-provisional application claiming priority to provisional application 61/620,045 filed Apr. 4, 2012 hereby expressly incorporated by reference herein.

### BACKGROUND

This relates to graphics processing.

Color data and depth data can be stored when a pixel is rendered. Depth data may be used to cull objects that would be hidden to avoid processing them. Depth testing determines which of two overlapping pixels is closer to the camera. The depth function determines what to do with the test result. A depth buffer may store per-pixel floating-point or integer depth data for each pixel rendered. A depth buffer may also contain stencil data which can be used to do more complex rendering such as simple shadows or outlines.

Reducing memory bandwidth usage in graphics processors is becoming increasingly important, both from a performance perspective and from a power efficiency perspective. The data traffic to and from the depth buffer consumes a significant amount of bandwidth, and it is therefore important to reduce this traffic as much as possible. Common approaches include Zmax-culling, Zmin-culling, depth caching, and depth compression.

### BRIEF DESCRIPTION OF THE DRAWINGS

Some embodiments are described with respect to the following figures:

FIG. 1 shows a compressed depth architecture according to one embodiment;

FIG. 2 depicts the computation of Zₘᵢₙ and Zₘₐₓ using a tree of comparisons for eight incoming depth values, zᵢ, i∈{0, . . . , 7} according to one embodiment;

FIG. 3 is a flow chart for a brute force codec according to one embodiment;

FIG. 4 is a flow chart for an opportunistic codec according to one embodiment;

FIG. 5 is a depiction of a two stage codec according to one embodiment;

FIG. 6 is a system depiction for one embodiment; and

FIG. 7 is a front elevational view of one embodiment.

### DETAILED DESCRIPTION

In one embodiment, the content in the depth cache is kept compressed when possible. The implication of this is that tiles (rectangular regions of samples/pixels) that can be compressed in the cache will utilize less storage there, and hence, the effective cache size is increased, with better performance as a result. Alternatively, the cache size can be reduced with unaffected cache performance.

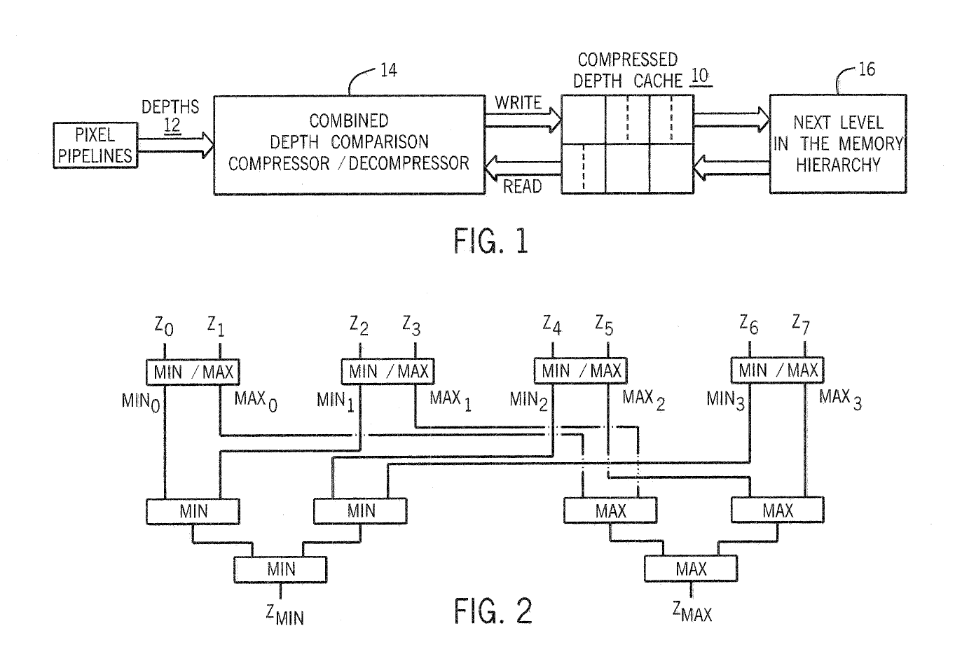

A depth cache 10, shown in FIG. 1, keeps the depth data 12 in compressed format when possible. This involves a more flexible cache implementation, where a tile may occupy a variable amount of cache lines depending on whether it can be compressed or not. One advantage of this depth cache, in some embodiments, is that the effective cache size increases proportionally to the compression ratio. The memory bandwidth can be reduced, compared to a system compressing the data after the cache in some embodiments. Alternatively, and perhaps more interestingly, pre-cache compression may increase the effective cache size by a factor of two or more, compared to a post-cache compressor, at equal or higher performance.

The content in the depth cache is kept compressed when possible, to efficiently perform depth comparisons as well as compression/decompression between the pixel pipelines and the compressed depth cache in combined depth comparison compressor/decompressor 14. The cache 10 may exchange data with longer term storage or the next level in the memory hierarchy 16. A more flexible cache may be used where the line size reflects what is efficient for a memory transaction.

Furthermore, the compression/decompression logic is placed before the cache, called a pre-cache codec. The benefits of this system are twofold in some embodiments. First, compressed tiles can be stored in the cache, thereby efficiently growing the effective cache size proportionally to the compression ratio in some embodiments. Second, the incompressible tiles may be split into sub-tiles, one for each line, and only the sub-tiles touched by a triangle may be updated in some embodiments. Since the compression algorithm is now placed before the cache, low latency and very high throughput are more desireable.

To combine pre-cache and post-cache codecs in the same system, one may ensure that the full tile exists in the cache in order to perform post-cache compression. Also, some operations, such as computing per-tile minimum (Zₘᵢₙ) and maximum (Zₘₐₓ) depth values, involves the full tile data. This can be achieved by allowing peeking in to the cache and check if the whole tile is present before evicting it. Since evictions are relatively infrequent this may be efficient.

However, an alternative approach is to allocate one extra bit per cache-line in the per-tile header data, and directly flag which sub-tiles are present in the cache. This operation is very efficient, but at the cost of a slight bandwidth increase for the tile headers.

This description focuses only on the plane encoding and depth offset compression algorithms, because they have simple implementations and can support incremental compression, which makes them good candidates for pre-cache codecs. Other traditional compression algorithms, such as anchor encoding, could also potentially be adapted for pre-cache compression. In one pipeline embodiment, a clear mask per tile is used to indicate which samples are cleared, so the minimum, Zₘᵢₙ, and maximum Zₘₐₓ, depth values for a tile is used are computed using only valid samples.

In plane encoding, the representation for a tile is a list of plane equations, and a per-sample bit mask that indicates which plane a sample belongs to. On-the-fly decompression from such a representation residing in the cache is straightforward.

Assume an intention to decompress the depth of a certain sample/pixel location, (xₛ,yₛ). The bit mask value is used as an index, i, into the set of plane equations, and the plane equation is simply evaluated as z=+c₀ⁱ+cₓⁱ·xₛ+c_{y}ⁱ·yₛ, where the constants c₀ⁱ, cₓⁱ, and c_{y}ⁱ together define plane equation i.

When a triangle is being rasterized, the rasterizer forwards the plane equation to the pre-cache codec. Depth comparisons are done by decompressing depth values as described above. If at least one depth value passes the depth test, the incoming plane equation is added to the compressed representation in the cache, and the bit masks updated for each affected sample/pixel. The size of the uncompressed tile will dictate how many plane equations can be stored in a compressed tile, and when there are no more available indices for new plane equations, the tile has to be decompressed and put into the cache again.

There are different strategies for adding a new plane. In the simplest implementation, the planes are just added to the list of planes and compression fails when too many planes overlap a tile. However, better compression is possible by deleting unused planes from the header, either by scanning the index bitmask for unused bit combinations, or by keeping counters of how many samples belong to each plane. In such an implementation, the compressor must be able to work with one more plane than is representable by the compressed format.

Depth offset is a very simple compression algorithm, but it works surprisingly well. It does not enable high compression ratios, but instead it is an algorithm that is activated for many tiles, and with moderate compression ratios. This makes it rather efficient overall. In addition, it is a simple algorithm from an implementation perspective. The compressed representation consists of two reference values, Zₘᵢₙ and Zₘₐₓ, a bit, m_{xy}, per sample that indicates whether a sample's residual is relative to Zₘᵢₙ or Zₘₐₓ, and then an n-bit per-sample residual, r_{xy}. The depth values are reconstructed as z(x,y)=Zₘᵢₙ+r_{xy} if m_{xy}=0, and otherwise as z(x, y)=Zₘₐₓ−r_{xy}.

The best bit distribution depends on the cache line size and the tile size. However, it is often sufficient to quantize Zₘᵢₙ and Zₘₐₓ to 16 bits precision, and use the remaining bits for the residuals. For compression, there are more options, and below, two different ways to compress the depth in a tile when a new triangle is being rasterized are presented.

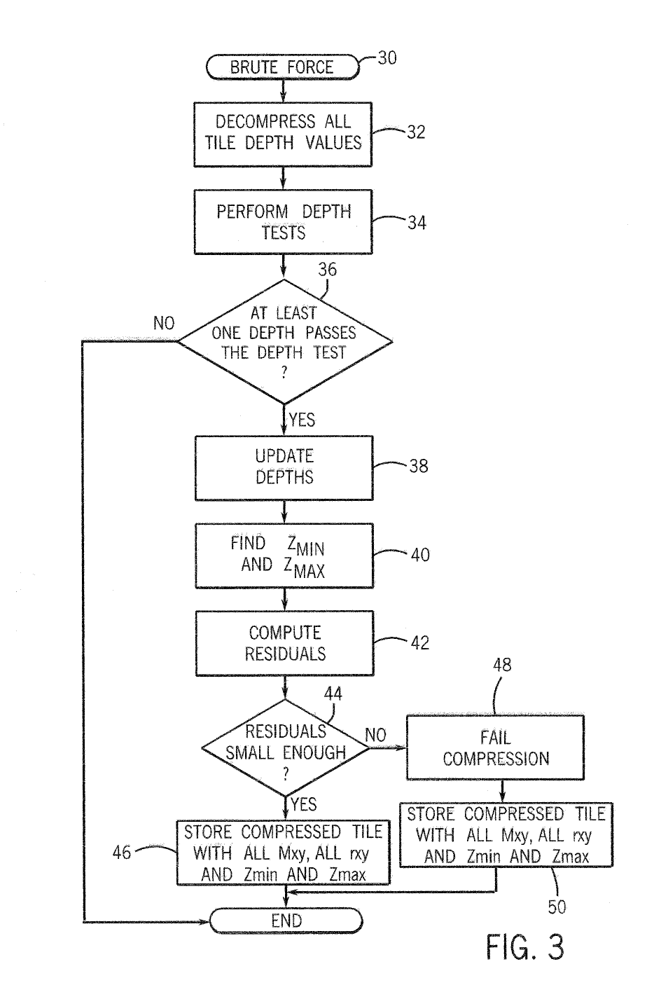

A brute force approach, as shown in FIG. 3, first decompresses all depth values (block 32) in the tile, performs depth tests (block 34), and updates at least one depth that passes the depth test (block 36). Then the Zₘᵢₙ and Zₘₐₓ of these depths are found (block 38) using, for example, a tree-like evaluation as shown in FIG. 2 using comparisons at each block for eight incoming depth values. Zᵢ, i∈{0, . . . , 7}.

In general, for s depths, such a tree will use s/2+2(s/2−1)=3s/2−2 comparisons to compute both Zₘᵢₙ and Zₘₐₓ (block 40).

The residuals, r_{xy}, and the selector bit, m_{xy}, are straightforward to compute. Residuals are computed (block 42) from Zₘᵢₙ and Zₘₐₓ, respectively. If residuals are small enough to encode in the given budget (diamond 44), the compressed tile is stored with all m_{xy} and r_{xy} and zₘᵢₙ and zₘₐₓ and set m_{xy} (block 46). Otherwise, the tile fails compression (block 48) and needs to be stored in uncompressed form (block 50).

Next, a conservative and less expensive approach to updating Zₘᵢₙ and Zₘₐₓ is described. The rest of the algorithm is intact though.

This compressor is based on the assumption that the depth pipeline supports hierarchical Zₘᵢₙ and zₘₐₓ-culling. These algorithms require conservative estimates of the minimum Zₘᵢₙ^{tri}, and the maximum depth, zₘₐₓ^{tri}, of a triangle inside a tile. Regardless of exactly how they are computed, we can assume they are readily available since the hierarchical culling unit is placed before the depth compression unit in the pipeline.

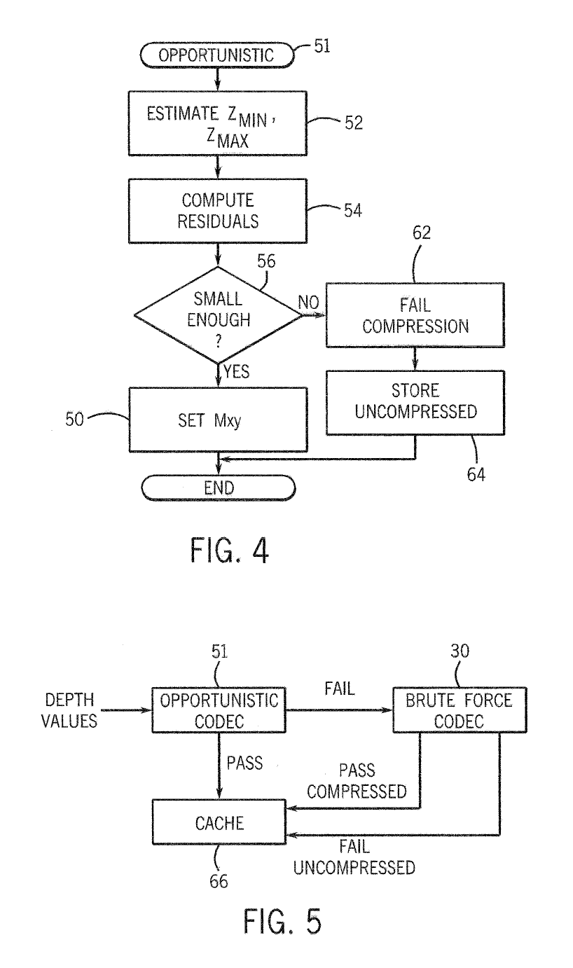

These estimates are exploited, as shown in FIG. 4, during compression by assuming that Zₘᵢₙ=min(Zₘᵢₙ,Zₘᵢₙ^{tri}), and Zₘₐₓ=max(Zₘₐₓ, Zₘₐₓ^{tri}) are good estimates for the true minimum and maximum values of the tile. After estimating Zₘᵢₙ and Zₘₐₓ (block 52) all residuals are computed (block 54). As a small optimization, only the triangle values are used if the current triangle overwrites the entire tile. Then a determination is made about whether the residual is small enough for the budget (diamond 56) and if so the compressed tile is stored with all m_{xy} and r_{xy} and zₘᵢₙ and zₘₐₓ block 58). Otherwise compression fails (block 60) and uncompressed (block 64) is stored.

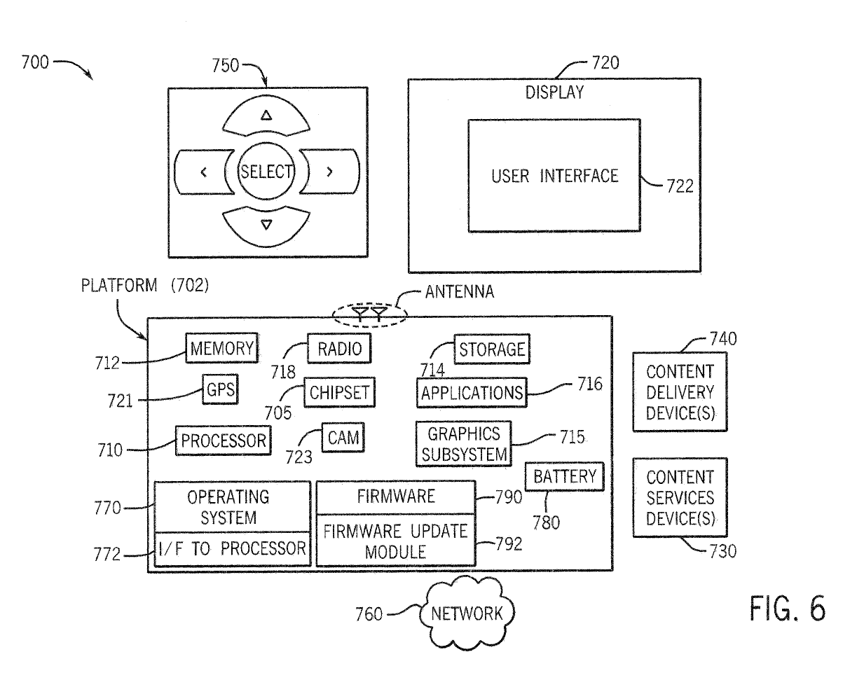

In practice, this will potentially cause the depth range to grow until a tile can no longer be compressed, unless fully overwritten. However, the implementation is more efficient as one can avoid the rather costly Zₘᵢₙ and Zₘₐₓ computations. This implementation may be combined with a post-cache brute force codec 30 as shown in FIG. 5. The simpler opportunistic codec 51 handles the high throughput data and keeps it compressed in the cache 66 for as long as possible. If the compression fails, the more expensive post-cache brute force codec 30 refines the Zₘᵢₙ and Zₘₐₓ values and re-compresses the tile if possible. When the data is read back into the cache, the pre-cache codec can use the refined values as a starting point.

Similar to depth offset compression, hierarchical depth culling keeps a lower resolution depth buffer that contains the maximum. Zₘₐₓ, and minimum, Zₘᵢₙ, depth values for each tile. Assuming a normal less than depth test, it is easy to update the minimum value as Zₘᵢₙ=min(Zₘᵢₙ,Z_{frag}) each time a new fragment is received. However, updating the Zₘₐₓ value is considerably more expensive and requires iterating over all the samples in the tile. Therefore, the Zₘₐₓ value is often updated opportunistically when a tile is evicted from the cache. This is acceptable since the previously stored Zₘₐₓ is conservative.

With this more flexible depth caching system it is possible to evict a partial tile, or sub-tile cannot be updated. In this case, the Zₘₐₓ value for that tile can not be updated, as it requires accessing all samples. In practice this is nota large problem since an efficient depth system will tweak the cache line size so that a compressed tile will fit in a single cache line, and consequently an uncompressed tile will typically fit in just a few lines.

Using a flexible depth cache may enable pre-cache data compression, and that such compression will roughly increase the cache size by the effective compression ratio. This can either be used to reduce bandwidth to random access memory (RAM), or to reduce cache size and free up silicon area without affecting bandwidth. In our implementation, a significant average relative bandwidth reduction may be achieved in some embodiments for reasonable pipelines, when compared to a post-cache codec. Similarly, the cache size can be reduced by the effective compression ratio with no impact on performance. In fact, the effective cache size may be more than doubled when going from a post-cache codec to a pre-cache codec. This is true for the depth offset only configuration, and to an even larger extent for the combined depth offset and plane encoding configuration.

FIG. 6 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716, global positioning system (GPS) 721, camera 723 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

In addition, the platform 702 may include an operating system 770. An interface to the processor 772 may interface the operating system and the processor 710.

Firmware 790 may be provided to implement functions such as the boot sequence. An update module to enable the firmware to be updated from outside the platform 702 may be provided. For example the update module may include code to determine whether the attempt to update is authentic and to identify the latest update of the firmware 790 to facilitate the determination of when updates are needed.

In some embodiments, the platform 702 may be powered by an external power supply. In some cases, the platform 702 may also include an internal battery 780 which acts as a power source in embodiments that do not adapt to external power supply or in embodiments that allow either battery sourced power or external sourced power.

The sequences shown in FIGS. 3, 4, and 5 may be implemented in software and firmware embodiments by incorporating them within the storage 714 or within memory within the processor 710 or the graphics subsystem 715 to mention a few examples. The graphics subsystem 715 may include the graphics processing unit and the processor 710 may be a central processing unit in one embodiment.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone. Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manlier. The embodiments, however, are not limited to the elements or in the context shown or described in FIG. 6.

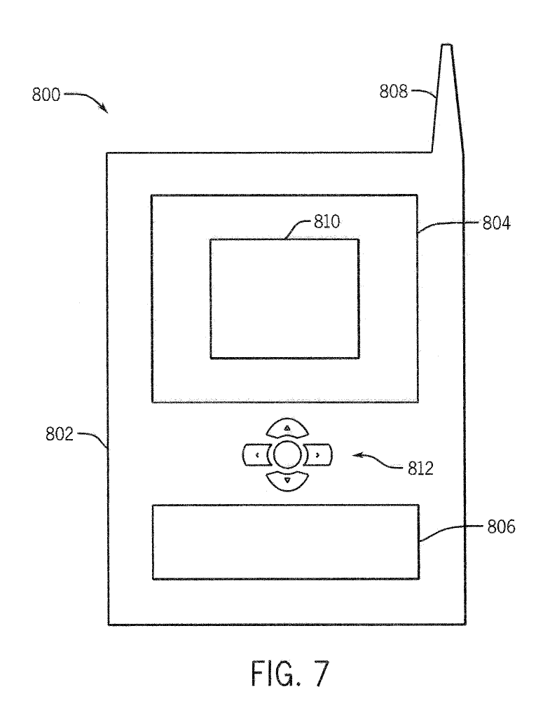

As described above, system 700 may be embodied in varying physical styles or form factors. FIG. 7 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
compressing depth data before storing the depth data in a depth cache.

2. The method of claim 1 including decompressing depth values, performing depth tests, and recompressing the result before updating the cache.

3. The method of claim 2 including decompressing only a subset of the depth data needed to perform said depth tests.

4. The method of claim 2 including updating depths that pass the depth test.

5. The method of claim 4 including computing minimum and maximum depths.

6. The method of claim 5 including computing residuals using the minimum and maximum depths.

7. The method of claim 6 including determining how the residuals compare to an encoder budget.

8. The method of claim 1 including estimating minimum and maximum depths.

9. The method of claim 8 including calculating a residual from estimated depths.

10. The method of claim 1 including performing a first depth test involving estimating maximum and minimum depths.

11. The method of claim 10 including performing a second depth test including calculating minimum and maximum depths and determining residuals if the first depth test fails.

12. One or more non-transitory computer readable media storing instructions executed by a computer to:
compress depth data before storing the depth data in a depth cache.

13. The media of claim 12 further storing instructions to decompress depth values, performed depth tests and recompress the result before updating the cache.

14. The media of claim 13 further storing instructions to decompress only the subset of the depth data needed to perform set depths.

15. The media of claim 13 further storing instructions to update depths that pass the depth test.

16. The media of claim 15 further storing instructions to compute minimum and maximum depths.

17. The media of claim 16 further storing instructions to compute residuals using minimum and maximum depths.

18. The media of claim 17 further storing instructions to determine how the residuals compare to an encoder budget.

19. The media of claim 12 further storing instructions that estimate minimum and maximum depths.

20. The media of claim 19 further storing instructions to calculate residuals from estimated depths.

21. The media of claim 12 further storing instructions to perform a first depth test involving estimating minimum and maximum depths.

22. The media of claim 20 further storing instructions to perform a second depth including calculating minimum and maximum depths, and determining residuals if the first depth test fails.

23. An apparatus comprising:
a depth cache; and
a processor to compress depth data before storing the depth data in a depth cache.

24. The apparatus of claim 23 said processor to decompress depth values, perform depth tests, and recompress the result before updating the cache.

25. The apparatus of claim 24 said processor to decompress only a subset of the depth data needed to perform said depth tests.

26. The apparatus of claim 24 said processor to update depths that pass the depth test.

27. The apparatus of claim 26 said processor to compute minimum and maximum depths.

28. The apparatus of claim 27, said processor to compute residuals using the minimum and maximum depths.

29. The apparatus of claim 28, said processor to determine how residuals compare to an encoder budget.

30. The apparatus of claim 23, said processor to estimate minimum and maximum depths and calculate a residual from said estimated depths.
